(19) United States
(12) Patent Application Publication
(10) Pub. No.: US 2019/0113455 A1
(43) Pub. Date: Apr. 18, 2019

(54) FLUORESCENCE OBSERVATION METHOD, FLUORESCENCE OBSERVATION DEVICE, AND LIGHT SHIELDING MEMBER

(71) Applicant: HAMAMATSU PHOTONICS K.K., Hamamatsu-shi, Shizuoka (JP)

(72) Inventors: Mitsuharu MIWA, Hamamatsu-shi, Shizuoka (JP); Takahiro SHIKAYAMA, Hamamatsu-shi, Shizuoka (JP)

(73) Assignee: HAMAMATSU PHOTONICS K.K., Hamamatsu-shi, Shizuoka (JP)

(21) Appl. No.: 16/089,389

(22) PCT Filed: Mar. 23, 2017
(86) PCT No.: PCT/JP2017/011831

§ 371 Date: Sep. 28, 2018

(30) Foreign Application Priority Data
Mar. 29, 2016 (JP) 2016-066390

(51) Int. Cl. G01N 21/64

(52) U.S. Cl. CPC G01N 21/6456; G01N 21/6428; G01N 2021/6439; G01N 2021/6463; G01N 2201/064

(57) ABSTRACT

A fluorescence observation method includes a fluorescence imaging step of imaging fluorescence from an observation target by an imaging portion. The fluorescence imaging step includes a darkening step of darkening a space between the observation target and an observation window of the imaging portion by pressing a tip end portion of a light shielding member to the observation target or a placement surface of the observation target, in a state where a base end portion of the light shielding member including a tubular main body portion is attached to the imaging portion to surround the observation window, and a focus adjustment step of adjusting a focus position of the imaging portion.

### TECHNICAL FIELD

One aspect relates to a fluorescence observation method, a fluorescence observation device, and a light shielding member.

### BACKGROUND ART

Recently, technology has been developed in which a fluorescence reagent such as a fluorescent dye is applied to an observation target such as a body tissue, and information is acquired by observing fluorescence generated at the observation target. For example, in the technology described in Non-patent Document 1, a fluorescence reagent in which a specific protein degradative enzyme having activity increased by a cancer cell, exhibits fluorescence, is sprayed onto the observation target, and a fluorescence image in which the cancer cell is selectively brightened, is observed, and thus identification between a normal tissue and a cancer cell is performed.

### CITATION LIST

### Non-Patent Literature

Non-patent Document 1: Yasuteru DRANO and 34 others, “Rapid intraoperative visualization of breast lesions with γ-glutamyl hydroxymethyl rhodamine green”, Scientific Reports, published on 13 July, 2015, p. 1-6

### SUMMARY OF INVENTION

### Technical Problem

In the fluorescence observation method as described above, the fluorescence from the observation target may be imperceptible. For this reason, in order to accurately identify the observation target according to the observation of the fluorescence image, it is important to exclude the influence of ambient light such as the background light for increasing an S/N ratio of the fluorescence to be observed.

In addition, in order for quantitative evaluation of the fluorescence image, it is desirable to set a distance between an imaging portion imaging the fluorescence and the observation target to be constant. However, in the field where the fluorescence is observed, it takes a lot of time to start the observation of the fluorescence if a positional relationship between the observation target and the imaging portion is manually adjusted whenever the observation is performed. Therefore, there is demand for technology in which the positional relationship between the observation target and the imaging portion can be simply adjusted.

An object of one aspect is to provide a fluorescence observation method, a fluorescence observation device, and a light shielding member.

### Solution to Problem

A fluorescence observation method according to one aspect includes: a fluorescence imaging step of imaging fluorescence from an observation target by an imaging portion, in which the fluorescence imaging step includes a darkening step of darkening a space between the observation target and an observation window of the imaging portion by pressing a tip end portion of a light shielding member to the observation target or a placement surface of the observation target, in a state where a base end portion of the light shielding member including a tubular main body portion is attached to the imaging portion to surround the observation window, and a focus adjustment step of adjusting a focus position of the imaging portion.

In the darkening step of the fluorescence observation method, the tip end portion of the light shielding member attached to surround the observation window is pressed to the observation target or the placement surface of the observation target, and thus the space is darkened between the observation target and the observation window. Accordingly, it is possible to exclude ambient light such as the background light from an imaging space, and to acquire a fluorescence image having a sufficient S/N ratio by the imaging portion. Therefore, it is possible to accurately perform the identification of the observation target. In addition, the tip end portion of the light shielding member in the fluorescence observation method is pressed to the observation target or the placement surface of the observation target, and thus a distance from the observation window to the position of the observation target can be the length of the main body portion of the light shielding member along the axis direction, in synchronization with the darkening of the space. Therefore, it is possible to simply perform quantitative evaluation of the light image.

The focus adjustment step may be performed before the darkening step, and the focus position of the imaging portion may be adjusted such that the focus position of the imaging portion becomes a position of a surface including the tip end portion of the light shielding member. In this case, the tip end portion of the light shielding member attached to surround the observation window is pressed to the observation target or the placement surface of the observation target, and thus it is possible to match the position of the observation target to the focus position of the imaging portion in synchronization with the darkening of the space.

A light shielding member having a tapered shape such that a sectional area of an inner space in the main body portion increases from the base end portion towards the tip end portion may be used as the light shielding member. In this case, it is possible to prevent a visual field of the imaging portion from being blocked by a wall portion of the light shielding member.

A light shielding member in which at least one of an inner surface and an outer surface of the main body portion is black may be used as the light shielding member. In this case, the background light can be absorbed by at least one of the inner surface and the outer surface of the main body portion, and thus it is possible to further increase an exclusion effect of ambient light due to the darkened space.

A light shielding member including a curved portion conforming to a shape of the observation target on the tip end portion may be used as the light shielding member. By forming the curved portion, it is possible to closely attach the tip end portion of the light shielding member along the shape of the observation target. Therefore, the space conforming to the shape of the observation target is easily darkened.

The fluorescence imaging step may further include a first attaching step of attaching a sterilized cover to the imaging portion to cover a portion excluding the observation window of the imaging portion, and a second attaching step of detachably attaching the base end portion of the light shielding member to an attachment portion with respect to the imaging portion in the sterilized cover. In this case, it is possible to image the fluorescence from the observation target in a clean state, without sterilizing the imaging portion itself. In addition, it is possible to easily attach and detach the light shielding member with respect to the imaging portion in a state where the sterilized cover is attached to the imaging portion.

The fluorescence observation method may further include a reagent applying step of applying a fluorescence reagent to the observation target, in which in the fluorescence imaging step, the observation target may be irradiated with excitation light, and fluorescence generated at the observation target in response to the irradiation of the excitation light is imaged by the imaging portion. In this case, selectively generating the fluorescence at the observation target by the fluorescence reagent makes it possible to accurately identify the observation target.

A fluorescence observation device according to one aspect includes: an imaging portion imaging fluorescence from an observation target; and a light shielding member including a tubular main body portion surrounding an observation window of the imaging portion, in which the main body portion of the light shielding member includes a base end portion detachably attached to the imaging portion, and a tip end portion pressed to the observation target or a placement surface of the observation target, and a length of the main body portion along an axis direction is a length wherein a surface including the tip end portion is included in a focus adjustment range of the imaging portion when the base end portion is attached to the imaging portion.

The fluorescence observation device includes the light shielding member including the tubular main body portion surrounding observation window of the imaging portion. The tip end portion of the light shielding member is pressed to the observation target or the placement surface of the observation target, and thus the space between the observation target and the observation window is darkened. Accordingly, it is possible to exclude ambient light such as the background light from the imaging space, and to acquire a fluorescence image having a sufficient S/N ratio by the imaging portion. Therefore, it is possible to accurately perform the identification of the observation target. In addition, the tip end portion of the light shielding member is pressed to the observation target or the placement surface of the observation target, and thus a distance from the observation window to the position of the observation target can be the length of the main body portion of the light shielding member along the axis direction, in synchronization with the darkening of the space. Therefore, it is possible to simply perform quantitative evaluation of the light image.

The main body portion may have a tapered shape such that a sectional area of an inner space increases from the base end portion towards the tip end portion. In this case, it is possible to prevent a visual field of the imaging portion from being blocked by a wall portion of the light shielding member.

At least one of an inner surface and an outer surface of the main body portion may be black. In this case, the background light can be absorbed by at least one of the inner surface and the outer surface of the main body portion, and thus it is possible to further increase an exclusion effect of ambient light due to the darkened space.

A curved portion conforming to a shape of the observation target may be provided on the tip end portion. By forming the curved portion, it is possible to closely attach the tip end portion of the light shielding member along the shape of the observation target. Therefore, the space conforming to the shape of the observation target is easily darkened.

A sterilized cover may be attached to the imaging portion to cover a portion excluding the observation window, and a detachable portion detachably attached to an attachment portion with respect to the imaging portion in the sterilized cover, may be provided on the base end portion. In this case, it is possible to image the fluorescence from the observation target in a clean state, without sterilizing the imaging portion itself. In addition, it is possible to easily attach and detach the light shielding member with respect to the imaging portion in a state where the sterilized cover is attached to the imaging portion.

A light shielding member according to one aspect includes: a tubular main body portion configured to surround an observation window of an imaging portion imaging fluorescence from an observation target, in which the main body portion includes a base end portion detachably attached to the imaging portion, and a tip end portion pressed to the observation target or a placement surface of the observation target, and a length of the main body portion along an axis direction is a length wherein a surface including the tip end portion is included in a focus adjustment range of the imaging portion when the base end portion is attached to the imaging portion.

The light shielding member includes the tubular main body portion configured to surround the observation window of the imaging portion. The tip end portion of the light shielding member is pressed to the observation target or the placement surface of the observation target, and thus the space between the observation target and the observation window is darkened. Accordingly, it is possible to exclude ambient light such as the background light from the imaging space, and to acquire a fluorescence image having a sufficient S/N ratio by the imaging portion. Therefore, it is possible to accurately perform the identification of the observation target. In addition, the tip end portion of the light shielding member is pressed to the observation target or the placement surface of the observation target, and thus a distance from the observation window to the position of the observation target can be the length of the main body portion of the light shielding member along the axis direction, in synchronization with the darkening of the space. Therefore, it is possible to simply perform quantitative evaluation of the light image.

The main body portion may have a tapered shape such that a sectional area of an inner space increases from the base end portion towards the tip end portion. In this case, it is possible to prevent a visual field of the imaging portion from being blocked by a wall portion of the light shielding member.

At least one of an inner surface and an outer surface of the main body portion may be black. In this case, the background light can be absorbed by at least one of the inner surface and the outer surface of the main body portion, and thus it is possible to further increase an exclusion effect of ambient light due to the darkened space.

A curved portion conforming to a shape of the observation target may be provided on the tip end portion. By forming the curved portion, it is possible to closely attach the tip end portion of the light shielding member along the shape of the observation target. Therefore, the space conforming to the shape of the observation target is easily darkened.

A detachable portion may be provided on the base end portion, wherein the detachable portion is detachably attached to an attachment portion with respect to the imaging portion in the sterilized cover attached to the imaging portion to cover a portion excluding the observation window. In this case, it is possible to image the fluorescence from the observation target in a clean state, without sterilizing the imaging portion itself. In addition, it is possible to easily attach and detach the light shielding member with respect to the imaging portion in a state where the sterilized cover is attached to the imaging portion.

### Effects of Invention

According to one aspect, it is possible to provide a fluorescence observation method, a fluorescence observation device, and a light shielding member, in which quantitative evaluation of a fluorescence image can be simply performed, and the observation target can be accurately identified.

### BRIEF DESCRIPTION OF DRAWINGS

FIG. 1 is a block diagram illustrating one embodiment of a fluorescence observation device.

FIG. 2 is a perspective view of an imaging unit of the fluorescence observation device of FIG. 1.

FIG. 3 is a sectional view of the imaging unit of the fluorescence observation device of FIG. 1.

FIG. 4 is a sectional view of the fluorescence observation device illustrated in a state where a sterilized cover and a light shielding member are attached to the fluorescence observation device.

FIG. 5 is a perspective view illustrating an example of a light shielding member.

FIG. 6 is a flowchart illustrating a fluorescence observation method to be executed in the fluorescence observation device of FIG. 4.

FIG. 7 is a flowchart illustrating a fluorescence imaging step in the fluorescence observation method of FIG. 6.

FIG. 8A is a diagram illustrating an example of a reagent applying step in the fluorescence observation method.

FIG. 8B is a diagram illustrating an example of a reagent applying step in the fluorescence observation method.

FIG. 9A is a diagram illustrating an example of a first attaching step in the fluorescence observation method.

FIG. 9B is a diagram illustrating an example of a first attaching step in the fluorescence observation method.

FIG. 10A is a diagram illustrating an example of a second attaching step in the fluorescence observation method.

FIG. 10B is a diagram illustrating an example of a darkening step in the fluorescence observation method.

FIG. 11 is a perspective view of a light shielding member according to a modification example.

FIG. 12 is a diagram for illustrating a darkening step of a fluorescence observation method to be executed in a fluorescence observation device including the light shielding member of FIG. 11.

FIG. 13 is a diagram for illustrating a darkening step of a fluorescence observation method to be executed in a fluorescence observation device including a light shielding member according to another modification example.

### DESCRIPTION OF EMBODIMENTS

Hereinafter, embodiments of a fluorescence observation device and a fluorescence observation method according to one aspect will be described in detail, with reference to the drawings.

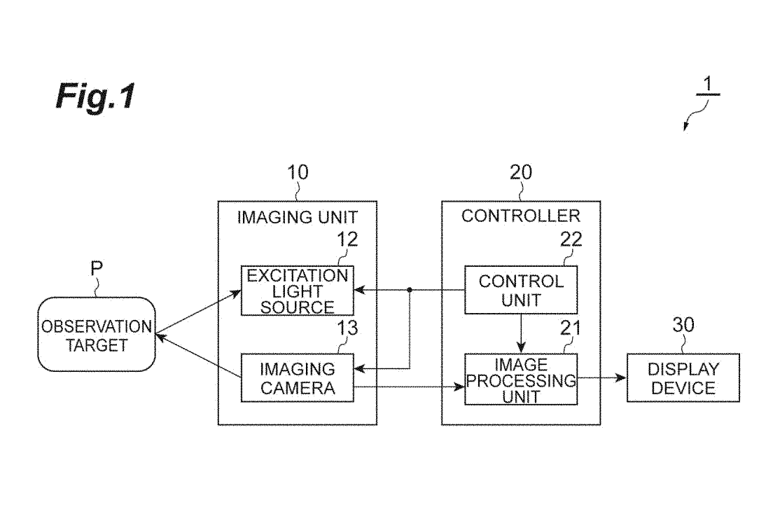

FIG. 1 is a block diagram illustrating a fluorescence observation device according to one embodiment. A fluorescence observation device 1 is a device which is used for identifying a specific state in an observation target P. The fluorescence observation device 1 has a function of displaying a fluorescence image which is obtained by imaging fluorescence from the observation target P. In the following description, the observation target P, for example, is a body tissue excised from a living body such as humans and animals, and the case of identifying the presence or absence of a cancer cell in the body tissue will be exemplified.

In the observation of the fluorescence image, for example, a reagent such as a fluorescence reagent is applied in advance to the observation target P. For example, the fluorescence reagent which has an excitation peak wavelength (an excitation wavelength) within a range of 300 nm to 810 nm, and generates fluorescence by being bonded to the cancer cell, is used as the reagent. The reagent contains a fluorescent dye such as indocyanine green or indocyanine blue, 5ALA, fluorescein, patent blue, and indigo carmine, a photosensitizer such as methylene blue, LASERPHYRIN, and photofrin, a biomarker such as Qdot (Registered Trademark), and the like. Specific examples of the fluorescence reagent include PROTEO GREEN (Registered Trademark)-gGlu. Such a fluorescence reagent reacts to the cancer cell having γ-glutamyltranspeptidase (GGT) activity, and generates fluorescence. The excitation peak wavelength is approximately 496 nm. The fluorescence peak wavelength is approximately 525 nm.

The fluorescence observation device 1, for example, is configured by including a handheld imaging unit (imaging portion) 10 imaging the fluorescence image, a controller 20 executing control with respect to the operation of the imaging unit 10 and image processing with respect to the fluorescence image, and a display device 30 displaying the fluorescence image. The imaging unit 10 is connected to the controller 20 through a communication cable C capable of mutual information communication. The display device 30 is connected to the controller 20 through a communication cable (not illustrated) capable of mutual the information communication. The imaging unit 10 may be connected to the controller 20 in a wireless manner capable of mutual the information communication.

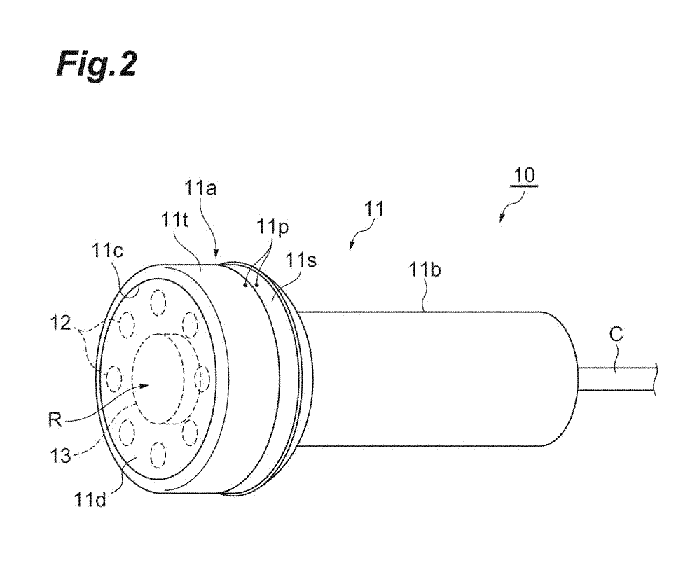

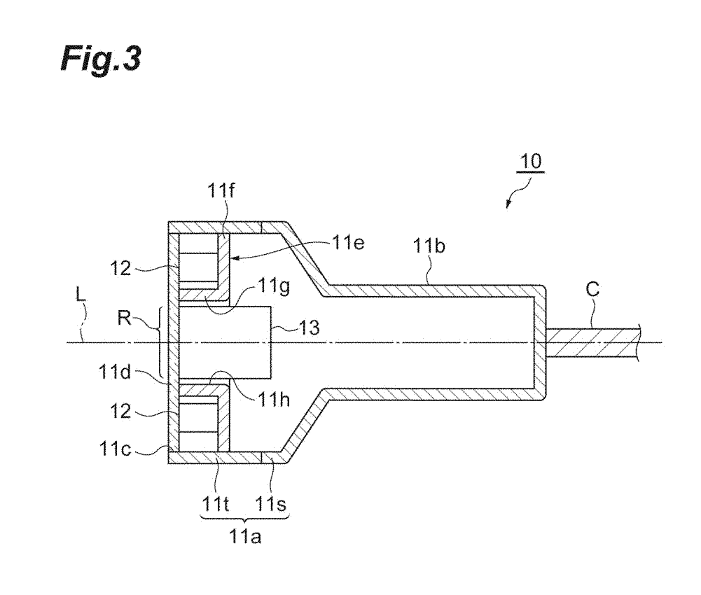

FIG. 2 is a perspective view of the imaging unit of the fluorescence observation device of FIG. 1. FIG. 3 is a sectional view of the imaging unit of the fluorescence observation device of FIG. 1. As illustrated in FIG. 2 and FIG. 3, the imaging unit 10 is configured of a case 11, an excitation light source 12, and an imaging camera 13. In the imaging unit 10, the observation target P is irradiated with excitation light of a predetermined wavelength. The imaging unit 10 is configured as a device acquiring an image on a surface of a tissue or in the tissue by observing the fluorescence image generated at the observation target P in response to the excitation light.

The case 11, for example, is formed of a metal member such as aluminum, copper, magnesium, and iron, approximately into the shape of a cylinder. A tip end portion 11a of the case 11 has a diameter larger than that of a rear end portion 11b, and a circular opening portion 11c is provided in the tip end. A transparent window member 11d is attached to cover the opening portion 11c. The communication cable C described above extends from the rear end portion 11b of the case 11. The tip end portion 11a includes a fixed portion 11s provided on the rear end portion 11b side, and a rotating portion 11t provided on the tip end side. The fixed portion 11s and the rotating portion 11t can be rotated with one another around a central axis of the opening portion 11c as a rotation axis. The tip end portion 11a is configured such that the rotating portion 11t is rotated with respect to the fixed portion 11s, and thus a focus lens (described below) of the imaging camera 13 is moved in an optical axis direction of the focus lens. The fixed portion 11s may be fixed to the rear end portion 11b.

The case 11 includes a base 11e for disposing the excitation light source 12. As with the case 11, the base 11e, for example, is formed of a metal member. The base 11e includes approximately a disk-like support body 11f, and a cylindrical light shielding wall 11g. The light shielding wall 11g is formed in an edge portion of the support body 11f. A circular opening portion 11h for allowing the fluorescence image from the observation target P to pass towards the imaging camera 13 is formed in the center of the base 11e. In the case 11, a portion of the window member 11d corresponding to the opening portion 11h, functions as an observation window R through which the fluorescence from the observation target P passes, in the imaging unit 10.

The excitation light source 12 is a portion emitting the excitation light for exciting the fluorescence. For example, a light emitting diode (LED), a semiconductor laser (LD), or the like is used as the excitation light source 12. For example, in a case where PROTEO GREEN-gGlu is used as the fluorescence reagent, it is preferable that the wavelength of the excitation light emitted from the excitation light source 12, is 300 nm to 650 nm. For example, in a case where indocyanine green is used as the fluorescence reagent, it is preferable that the wavelength of the excitation light emitted from the excitation light source 12, is 700 nm to 810 nm. Here, wavelength of the fluorescence of indocyanine green is approximately 830 nm, and thus in a case where it is necessary to separate the fluorescence from the excitation light, it is preferable that the wavelength of the excitation light emitted from the excitation light source 12, is approximately 760 nm.

A plurality of excitation light sources 12 are respectively mounted on the base 11e, and are arranged around the observation window R, into a cyclic shape. The imaging camera 13 is disposed inside the case 11. An optical axis of the imaging camera 13 is coincident with a central axis L of the opening portion 11h in the base 11e. The imaging camera 13 is configured by including a focus lens adjusting a focal point position (hereinafter, simply referred to as a “focus position”) of a focus lens of the imaging camera 13. For example, a driving unit such as a lens mount is provided in the focus lens. The focus lens of the imaging camera 13 is driven in a direction along the optical axis by the driving unit, and thus the focus position can be adjusted. The focus position can be adjusted, and thus an observation distance, which is a distance from the observation window R of the imaging camera 13 to the focus position, can be changed. In the tip end portion 11a of the imaging unit 10, the rotating portion 11t is rotated along with the driving unit. The rotating portion 11t is rotated with respect to the fixed portion 11s by the driving unit, and thus the focus lens can be moved in the optical axis direction. Accordingly, the imaging camera 13 is capable of changing the observation distance in a focus adjustment range. The focus adjustment range, for example, is a range of 50 mm to 300 mm. That is, the imaging camera 13 is capable of changing the observation distance within the range of 50 mm to 300 mm. The imaging camera 13 is capable of adjusting the focus position such that the observation distance becomes a length H of a tubular main body portion 51 of a light shielding member 50. The adjustment of the observation distance may be automatic adjustment in which the observation distance becomes the length H of the main body portion 51, or may be manual adjustment according to a user of the fluorescence observation device 1, in which the observation distance becomes the length H of the main body portion 51. In a case where the adjustment of the observation distance is the manual adjustment, for example, the user of the fluorescence observation device 1 may realize the adjustment of the observation distance by matching a mark 11p provided in the rotating portion 11t of the tip end portion 11a to a mark 11p provided in the fixed portion 11s of the tip end portion 11a. The user of the fluorescence observation device 1 may rotate the fixed portion 11s with respect to the rotating portion 11t.

The excitation light source 12 receives the control from the controller 20, and thus ON/OFF of the irradiation of the excitation light is switched. ON of the irradiation of the excitation light, for example, is a state where the excitation light source 12 is turned on. OFF of the irradiation of the excitation light, for example, is a state where the excitation light source 12 is turned off. In addition, OFF of the irradiation of the excitation light is not limited to only a case where the irradiation of the excitation light is completely stopped, and includes a case where the intensity of the excitation light is smaller than that of a case where the excitation light is ON.

The imaging camera 13 is a portion imaging the fluorescence image. The imaging camera 13 is configured of a spectral filter which cuts light in an excitation light wavelength range, and transmits light in a fluorescence wavelength range, and an imaging element imaging the fluorescence image through the spectral filter. For example, a CCD image sensor which is capable of acquiring a two-dimensional image, or an area image sensor such as a CMOS image sensor is used as the imaging element. It is preferable that an element having high sensitivity with respect to a wavelength band of the fluorescence image is used as the imaging element. The imaging camera 13 transmits image data of the acquired fluorescence image to the controller 20. A shutter operation of the imaging camera 13 is controlled by the controller 20.

The controller 20 is physically a hardware system configured of a memory such as a RAM and a ROM, and a computer system in which a processor (an arithmetic circuit) such as a CPU is built, a field-programmable gate array (FPGA), a digital circuit, or the like. Examples of the computer system include a personal computer or a microcomputer, a smart device, a cloud server, and the like. As illustrated in FIG. 1, the controller 20 includes an image processing unit 21 and a control unit 22, as functional constituents. In the controller 20, a program stored in the memory is executed by the CPU, and thus processing in the image processing unit 21 and the control unit 22 is executed.

The image processing unit 21 executes image processing based on the image data transmitted from the imaging camera 13, and generates an observation image. The image processing unit 21 generates a background image which is an image of a background of the observation target P, and a fluorescence image which is an image of a fluorescence generated at the observation target P, based on image data acquired when the irradiation of the excitation light is OFF, and image data acquired when the irradiation of the excitation light is ON. The image processing unit 21 generates an observation image including the background image and the fluorescence image, and adjusts the brightness (a pixel value) of the background image and the fluorescence image of the observation image. The image processing unit 21, for example, executes black level adjustment, gain adjustment, and the like with respect to the obtained fluorescence image data. The image processing unit 21 outputs the observation image obtained according to the image processing, to the display device 30. The observation image generated by the image processing unit 21 may be any one of a moving image and a still image.

The control unit 22, for example, receives an instruction of output start of the excitation light of the excitation light source 12, the input of an image acquisition condition such as a frame rate or a contrast, and the like, from an input unit (not illustrated), and thus controls the operation of the excitation light source 12 and the imaging camera 13. The control unit 22 controls the irradiation of the excitation light of the excitation light source 12, and the shutter operation of the imaging camera 13.

The display device 30 is a device displaying the observation image which is generated by the image processing unit 21. For example, a CRT monitor, a liquid crystal display attached to the imaging camera 13, and the like can be used as the display device 30. An image output device other than the display device 30 may be provided in the fluorescence observation device 1. The fluorescence observation device 1 may be configured to output image data of the obtained observation image to the external device, instead of providing the display device 30.

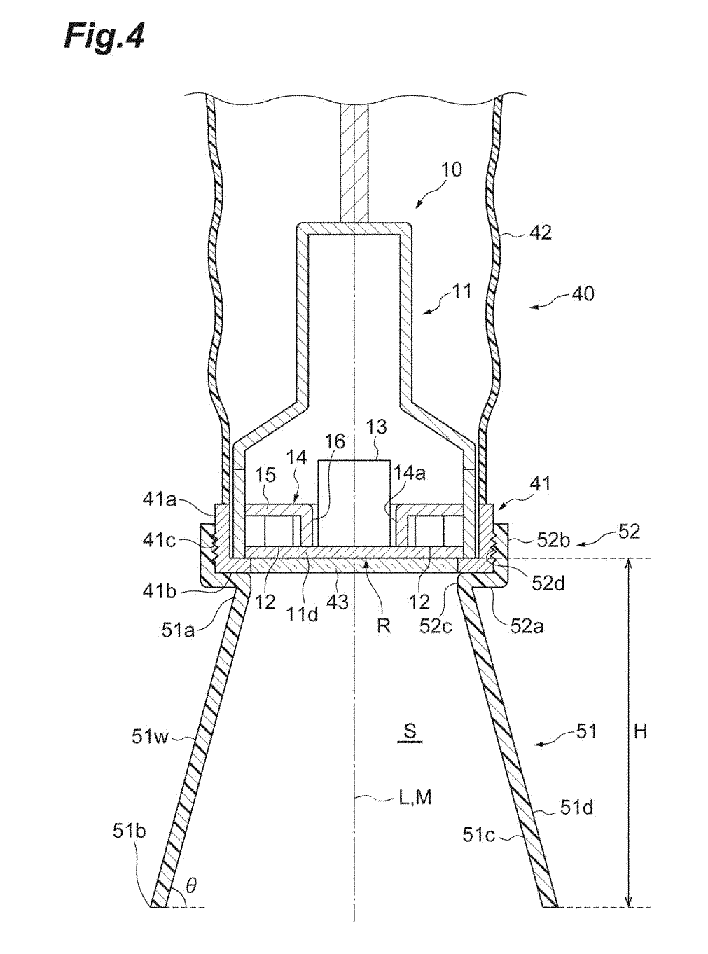

In a case where the observation target P is observed by using the fluorescence observation device 1 described above, a sterilized cover 40 and a light shielding member 50 are attached to the fluorescence observation device 1. FIG. 4 is a sectional view of the fluorescence observation device in a state where the sterilized cover and the light shielding member are attached the imaging unit 10. The sterilized cover 40 is a member for maintaining the periphery of the imaging unit 10 in a clean state. As illustrated in FIG. 4, the sterilized cover 40 includes an attachment portion 41 fitted into the outside of the tip end portion 11a of the imaging unit 10, a bag portion 42 provided on a base end side of the attachment portion 41, and a window member 43 provided on a tip end side of the attachment portion 41.

The attachment portion 41 includes an annular tubular portion 41a coaxial with the central axis L, and a flange portion. 41b provided inwardly on a tip end side of the tubular portion 41a. The tubular portion 41a and the flange portion 41b, for example, are integrally molded by a resin such as rubber. An inner diameter of the tubular portion 41a is identical to an outer diameter of the tip end portion 11a of the imaging unit 10. A screw portion 41c used for the attachment and detachment of the light shielding member 50, is formed on an outer circumference surface of the tubular portion 41a. The flange portion 41b has a protruding length of approximately a case thickness of the tip end portion 11a of the imaging unit 10, on the tip end side of the tubular portion 41a.

The bag portion 42, for example, is formed of a plastic film or the like, having transparency with respect to visible light. The bag portion 42 has a sufficient length for wrapping around the imaging unit 10 and the communication cable C, and is contained in a state of being folded on the base end side of the attachment portion 41, in an initial state. The window member 43, for example, is a plastic plate having transparency with respect to the excitation light and the fluorescence. The window member 43 is in the shape of a circular plate having an area equivalent to that of the window member 11d, in the imaging unit 10, and the thickness of the window member 43 is the same degree as the thickness of the flange portion 41b. The window member 43 is fitted into an opening portion of the tubular portion 41a which is partitioned by the flange portion 41b to be flush with the flange portion 41b.

All of the attachment portion 41, the bag portion 42, and the window member 43 are in a state of being sterilized according to sterilization processing. When the sterilized cover 40 is attached to the imaging unit 10, first, the attachment portion 41 is engaged with the tip end portion 11a of the imaging unit 10 while passing through the bag portion 42 in a state of being folded, and the window member 11d of the imaging unit 10 is brought into contact with the inside surface of the window member 43. When the attachment portion 41 is engaged with the imaging unit 10, the bag portion 42 is drawn out to the rear end portion 11b and the communication cable C side of the imaging unit 10. Accordingly, the imaging unit 10 and the communication cable C are covered with the sterilized cover 40, and the configuration around the imaging unit 10 is maintained in a clean state.

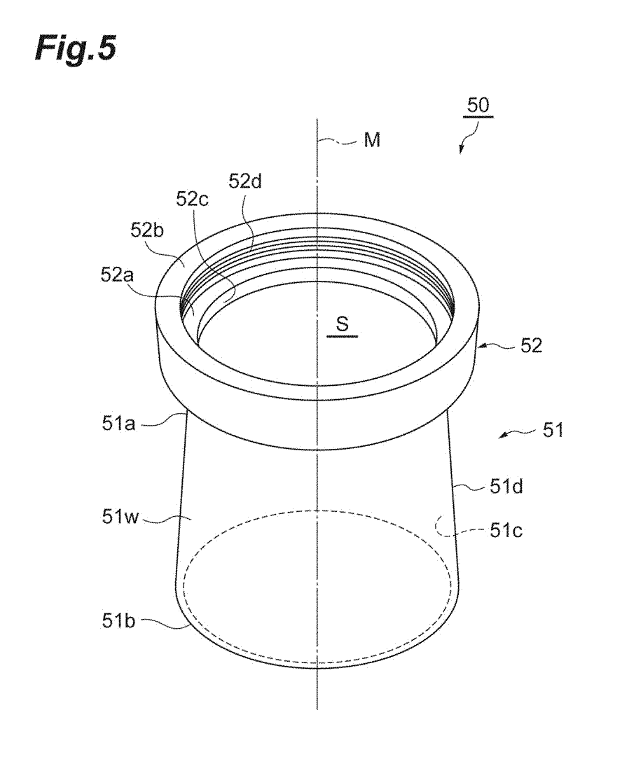

The light shielding member 50 is a member for darkening a space between the observation target P and the observation window R. As illustrated in FIG. 4 and FIG. 5, the light shielding member 50 includes the main body portion 51 including a base end portion 51a attached to the imaging unit 10 through the sterilized cover 40, and a tip end portion 51b pressed to the observation target or a placement surface of the observation target. A detachable portion 52 for detachably attaching the light shielding member 50 to the imaging unit 10 is provided on the base end portion 51a. The main body portion 51 is approximately in the shape of a truncated cone as a whole, and includes an inner space S in a wall portion 51w. A configuration material of the main body portion 51 is not particularly limited. It is preferable that the configuration material of the main body portion 51, for example, is a resin such as polypropylene or polystyrene, polyvinyl chloride, and polyethylene, from the viewpoint of the material cost, easiness in manufacturing, or the like.

The main body portion 51 has a tapered shape, for example, a sectional area of the inner space S increases from the base end portion 51a towards the tip end portion 51b, such that a visual field of the imaging camera 13 is not blocked by the wall portion 51w. An opening diameter of the base end portion 51a side, is equivalent to or slightly greater than the diameter of the of the window member 11d of the imaging unit 10. An opening diameter of the tip end portion 51b side is greater than an opening of the base end portion 51a side. A tapered angle θ of the main body portion 51, for example, is set to approximately 40° to 90°, such that the visual field of the imaging camera 13 is not blocked by the wall portion 51w. The tapered angle θ of the main body portion 51, for example, may be set to 45° to 85°.

At least one of an inner surface 51c and an outer surface 51d of the main body portion 51 is black over the entire surface. A method of blackening the main body portion 51 is not particularly limited. The method of blackening the main body portion 51 may be coating of a black coating material, or may be pasting of black papers, black resin sheets, or the like. The length of the main body portion 51 is set to be included in the focus adjustment range of the imaging camera 13 (a range in which the observation distance can be adjusted). Specifically, the length of the main body portion 51 is a length from the end of the base end portion 51a along a direction of a central axis M of the main body portion 51 (a position corresponding to the observation window R) to the end of the tip end portion 51b. That is, the length of the main body portion 51 is set to be capable of being adjusted such that the focus position of the imaging camera 13 becomes a position of a surface including the tip end portion 51b, in a state where the light shielding member 50 is attached to the imaging unit 10 by the detachable portion 52. It is necessary to change the focus position of the imaging camera 13 according to the type of observation target P. For this reason, the light shielding member 50 in which the length of the main body portion 51 is changed according to the observation target P, may be attached to the imaging unit 10, and thus the focus position may be changed.

The detachable portion 52 includes a step portion 52a protruding to the outside in a diameter direction from the base end portion 51a of the main body portion 51, and an annular tubular portion 52b provided to be coaxial with the central axis M on the outer edge of the step portion 52a. The detachable portion 52 may be integrally molded with the main body portion 51 by the same material as that of the main body portion 51. The detachable portion 52 may be separately molded from the main body portion 51, and may be joined to the base end portion 51a of the main body portion 51. A configuration material of the detachable portion 52 may be a resin different from the configuration material of the main body portion 51.

The step portion 52a includes an opening portion 52c communicated with the inner space S of the main body portion 51, on the inside in the diameter direction. The opening portion 52c has a diameter approximately identical to the diameter of the opening portion 11c of the imaging unit 10. An inner diameter of the tubular portion 52b is approximately identical to an outer diameter of the tubular portion 41a of the attachment portion 41 in the sterilized cover 40. A screw portion 52d to be screwed to the screw portion 41c of the attachment portion 41 is formed on an inner circumference surface of the step portion 52a. The screw portion 52d of the detachable portion 52 is screwed to the screw portion 41c of the attachment portion 41, and thus the light shielding member 50 is detachably attached to the imaging unit 10, and the observation window R of the imaging unit 10 becomes surrounded by the main body portion 51.

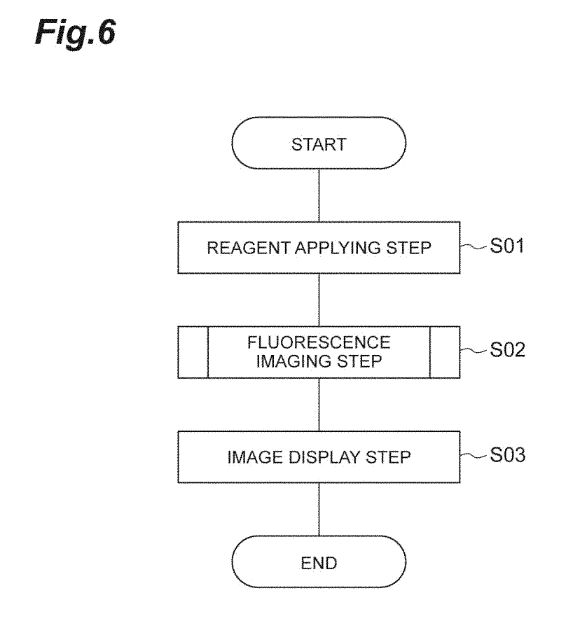

A fluorescence observation method to be executed by using the fluorescence observation device 1 configured as described above, will be described with reference to FIG. 6 to FIG. 10B.

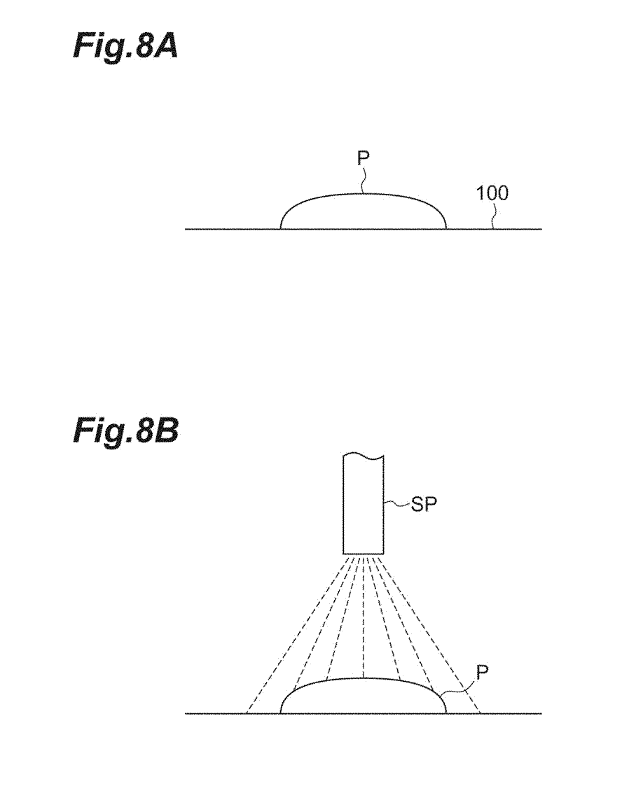

As illustrated in FIG. 6, in the fluorescence observation method, first, a reagent applying step is performed (S01). In the reagent applying step S01, the observation target P is prepared, and the fluorescence reagent is applied onto a surface of the observation target P. Specifically, in the reagent applying step S01, as illustrated in FIG. 8A, a body tissue excised from a living body such as humans and animals is prepared as the observation target P, and is placed on a placement surface 100. Then, as illustrated in FIG. 8B, in a state where the observation target P is placed on the placement surface 100, the fluorescence reagent is applied onto the observation target P. In an example of FIG. 8B, a predetermined amount of fluorescence reagent is sprayed onto the surface of the observation target P by a spray device SP. Accordingly, a suitable amount of fluorescence reagent is applied onto the surface of the observation target P.

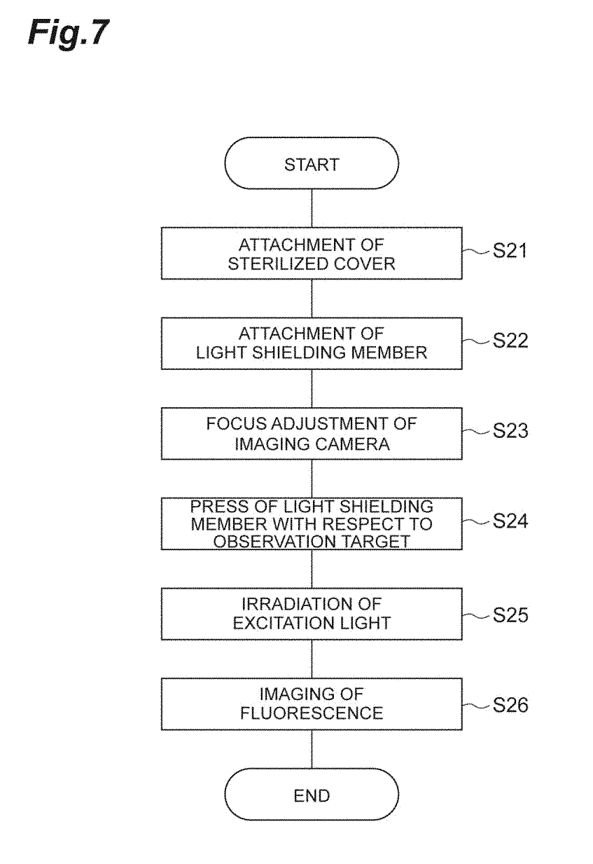

Subsequently, a fluorescence imaging step of imaging the fluorescence from the observation target P by the imaging unit 10, is performed (S02). After the fluorescence imaging step S02, a display step of displaying an observation image obtained in the fluorescence imaging step S02, by the display device 30, is performed (S03). As illustrated in FIG. 7, the fluorescence imaging step S02 includes a first attaching step (S21), a second attaching step (S22), a focus adjustment step (S23), a darkening step (S24), an excitation light irradiation step (S25), and an imaging step (S26).

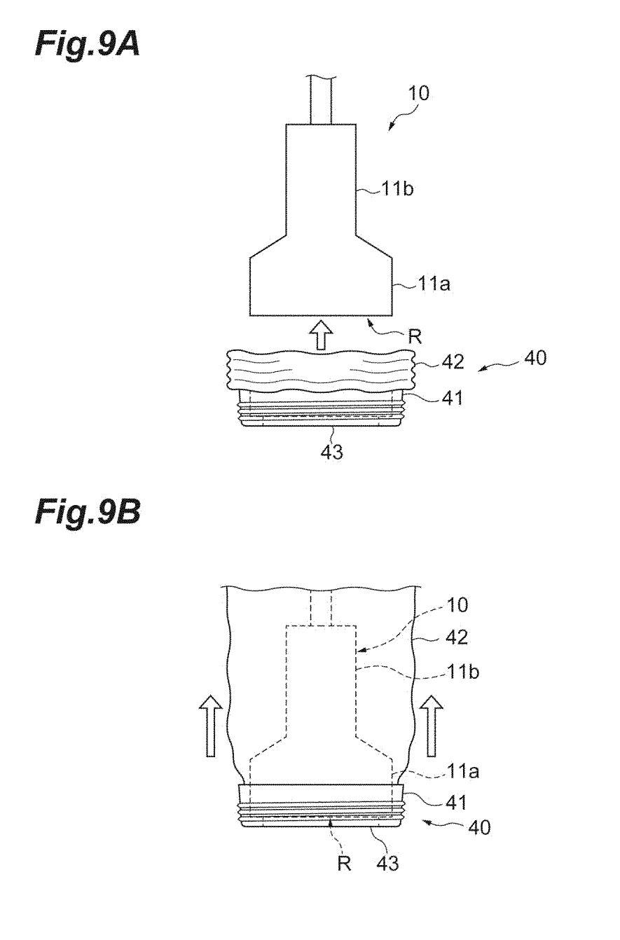

In the first attaching step S21, the sterilized cover 40 is attached to the imaging unit 10 to cover a portion excluding the observation window R of the imaging unit 10. First, as illustrated in FIG. 9A, the attachment portion 41 is engaged with the tip end portion 11a of the imaging unit 10 while passing through the bag portion 42 in a state of being folded, and the window member 11d of the imaging unit 10 is brought into contact with the inside surface of the window member 43. After that, as illustrated in FIG. 9B, the attachment portion 41 is engaged with the imaging unit 10, and then, the bag portion 42 is drawn out to the rear end portion 11b and the communication cable C side of the imaging unit 10. Accordingly, the imaging unit 10 and the communication cable C are covered with the sterilized cover 40, and the configuration around the imaging unit 10 is maintained in a clean state.

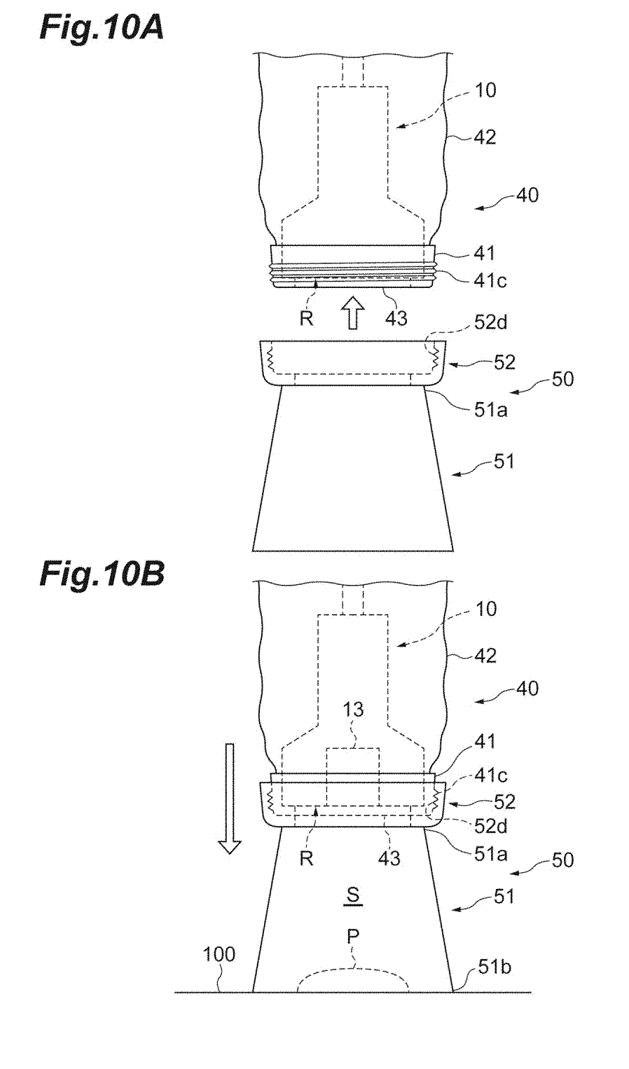

In the second attaching step S22 (refer to FIG. 7), as illustrated in FIG. 10A, the detachable portion 52 is engaged with the attachment portion 41 of the sterilized cover 40, and the screw portion 52d of the detachable portion 52 is screwed to the screw portion 41c of the attachment portion 41, and thus the light shielding member 50 is attached to the attachment portion 41 of the sterilized cover 40. Accordingly, the observation window R of the imaging unit 10 becomes surrounded by the main body portion 51.

In the focus adjustment step S23 (refer to FIG. 7), the focus position of the imaging camera 13 is adjusted such that the observation distance of the imaging camera 13 becomes the length H of the tubular main body portion 51 of the light shielding member 50. The focus adjustment step S23 may be performed before the second attaching step S22, or may be performed after the darkening step S24 described below.

In the darkening step S24, as illustrated in FIG. 10B, the tip end portion 51b of the light shielding member 50 is pressed to the placement surface 100 of the observation target P. As described above, at least one of the inner surface 51c and the outer surface 51d of the main body portion of the light shielding member 50 is black. The observation distance of the imaging camera 13 is set to correspond to the length of the main body portion 51. Therefore, the tip end portion 51b of the light shielding member 50 is pressed to the placement surface 100 of the observation target P, and thus the space (the inner space S) between the observation target P and the observation window R can be darkened, and the position of the observation target P can be matched to the observation distance of the imaging camera 13. Note that, according to the size, the shape, or the like of the observation target P, the focus position of the imaging camera 13 may not be matched to the position of the observation target P by only pressing the tip end portion 51b of the light shielding member 50 to the placement surface 100. Therefore, the focus position of the imaging camera 13 is further adjusted, and thus the focus position of the imaging camera 13 may be matched to the position of the observation target P.

In the excitation light irradiation step S25 (refer to FIG. 7), the observation target P is irradiated with the excitation light, after the darkening of the space and the positioning between the observation target P and the focus position of the imaging camera 13 described above. Then, in the imaging step S26, the fluorescence generated at the observation target P in response to the irradiation of the excitation light is imaged by the imaging unit 10, and the observation image is obtained by the image processing of the fluorescence image.

As described above, according to the fluorescence observation device 1, the fluorescence observation method to be executed in the fluorescence observation device 1, and the light shielding member 50, the tip end portion 51b of the light shielding member 50 attached to surround the observation window R is pressed to the placement surface 100 of the observation target P, and thus the space between the observation target P and the observation window R is darkened. Accordingly, it is possible to exclude ambient light such as the background light from an imaging space (the inner space S), and to acquire the fluorescence image having a sufficient S/N ratio by the imaging unit 10. Therefore, it is possible to accurately perform the identification of the observation target P. In addition, the focus adjustment step S23 is performed before the darkening step S24, and thus the tip end portion 51b of the light shielding member 50 is pressed to the placement surface 100 of the observation target P, and therefore, the position of the observation target P can be matched to the focus position of the imaging camera 13, on the basis of the length H of the tubular main body portion 51 of the light shielding member 50, in synchronization with the darkening of the space. Therefore, it is possible to simply perform quantitative evaluation of the fluorescence image.

In this embodiment, the fluorescence imaging step S02 further includes the first attaching step S21 of attaching the sterilized cover 40 to the imaging unit 10 to cover the portion excluding the observation window R of the imaging unit 10, and the second attaching step S22 of detachably attaching the base end portion 51a of the light shielding member 50 to the attachment portion 41 with respect to the imaging unit 10 in the sterilized cover 40. Accordingly, it is possible to image the fluorescence from the observation target P in a clean state, without sterilizing the imaging unit 10 itself. In addition, it is possible to easily attach and detach the light shielding member 50 with respect to the imaging unit 10 in a state where the sterilized cover 40 is attached to the imaging unit 10.

In this embodiment, the reagent applying step S01 of applying the fluorescence reagent onto the observation target P is further included, and in the fluorescence imaging step S02, the observation target P is irradiated with the excitation light, and the fluorescence generated at the observation target P is imaged by the imaging camera 13 in response to the irradiation of the excitation light. Accordingly, selectively generating the fluorescence at the observation target P by the fluorescence reagent makes it possible to accurately identify the observation target P.

In this embodiment, the main body portion 51 of the light shielding member 50 has a tapered shape such that the sectional area of the inner space S increases from the base end portion 51a towards the tip end portion 51b. Accordingly, it is possible to prevent the visual field of the imaging camera 13 from being blocked, by the wall portion 51w of the light shielding member 50.

In this embodiment, at least one of the inner surface 51c and the outer surface 51d of the main body portion 51 in the light shielding member 50 is black. Accordingly, it is possible to absorb the background light by at least one of the inner surface 51c and the outer surface 51d, and thus it is possible to further increase an exclusion effect of ambient light due to the darkened space.

In this embodiment, in a case where the observation target P is observed by the fluorescence observation device 1, the sterilized cover 40 is attached to the imaging unit 10, and the light shielding member 50 is detachably attached to the attachment portion 41 with respect to the imaging unit 10 in the sterilized cover 40. Accordingly, it is possible to image the fluorescence from the observation target P in a clean state, without sterilizing imaging unit 10 itself. In addition, it is possible to easily attach and detach the light shielding member 50 with respect to the imaging unit 10 in a state where the sterilized cover 40 is attached to the imaging unit 10.

One embodiment is not limited to the embodiment described above.

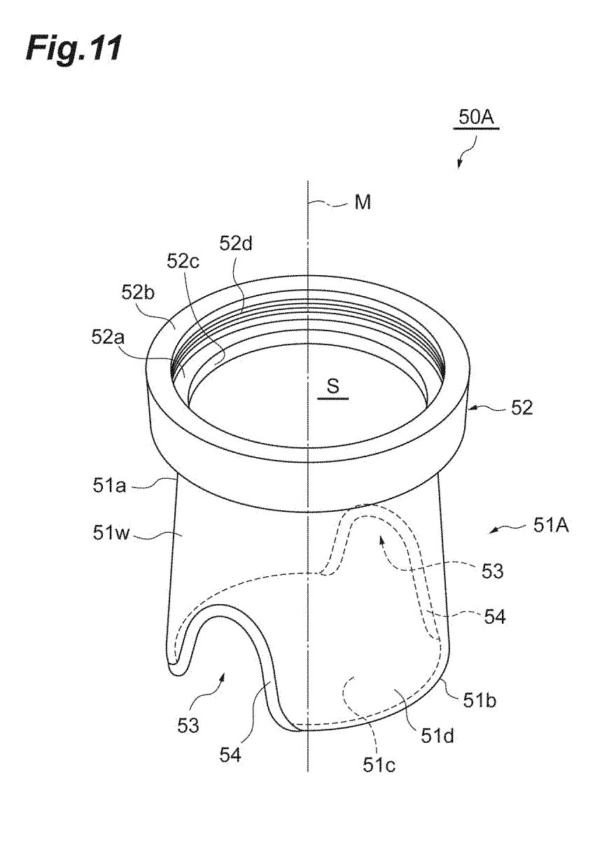

For example, in the embodiment described above, a case is exemplified in which the observation target P is the body tissue excised from the living body, and the observation target P is placed on the placement surface 100. However, the observation target P may be a part of a human body or the like, and the observation target P may be directly observed. In this case, a curved portion conforming to the shape of the observation target P may be provided in the tip end portion 51b of the light shielding member 50. FIG. 11 is a modification example of the light shielding member in a case where an arm portion of a human body is set to the observation target P. In a light shielding member 50A illustrated in the same drawing, a pair of curved portions 53 are provided in the tip end portion 51b. In the curved portion 53, the wall portion 51w is in a state of being cut out towards the base end portion 51a into the shape of a recess, conforming to a sectional shape of the arm portion.

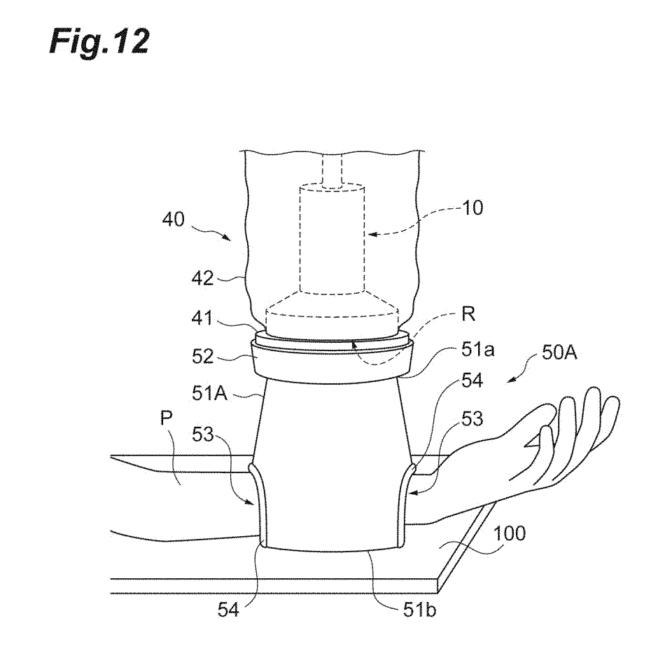

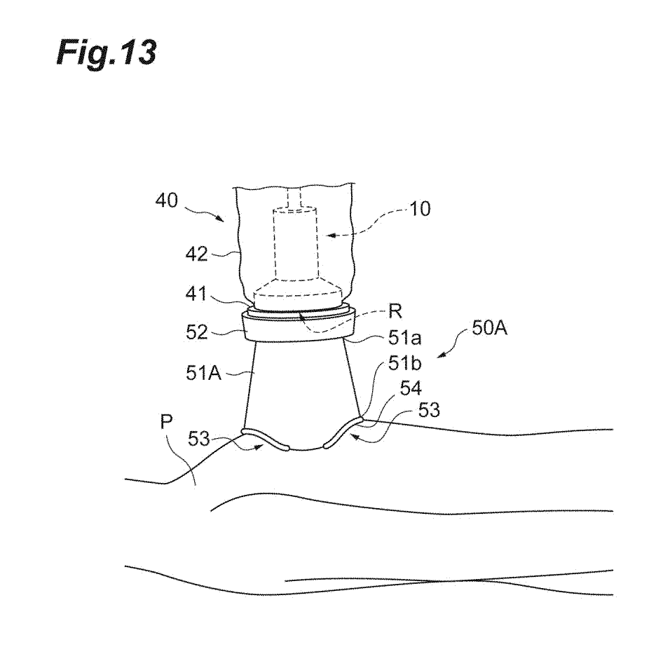

In addition, an elastic member 54 is provided in the edge portion of the curved portion 53. The elastic member 54 is disposed only in the edge portion of the curved portion 53, and thus it is possible to alleviate a pressure when pressing the light shielding member 50 to the observation target P, and to ensure following capability with respect to the observation target P, and it is also possible to sufficiently ensure shape retainability of the light shielding member 50A. For example, it is preferable that a black sponge is used as the elastic member 54. In this case, an effect of the darkening of the space according to the light shielding member 50A is not inhibited. In a case of using the light shielding member 50A, as illustrated in FIG. 12, the curved portion 53 may be applied to the arm portion disposed on the placement surface 100, and the tip end portion 51b of the light shielding member 50A may be pressed to the placement surface 100. In addition, in a case where the observation target P is a breast portion of the human body, as illustrated in FIG. 13, the shape of the curved portion 53 is a smooth curve compared to the case of FIG. 12. Then, the tip end portion 51b of the light shielding member 50A including the curved portion 53 may be pressed to the breast portion.

In the embodiment described above, the main body portion 51 is approximately in the shape of a truncated cone as a whole, but the shape of the main body portion 51 is not limited thereto. For example, the main body portion 51 may be approximately in the shape of a truncated pyramid. In this case, the opening of the base end portion 51a side is equivalent to or slightly larger than the size of the observation window R in the window member 11d of the imaging unit 10. An opening of the tip end portion 51b side is larger than the opening of the base end portion 51a side.

In the embodiment described above, the main body portion 51 has a tapered shape such that the sectional area of the inner space S increases from the base end portion 51a towards the tip end portion 51b, but the shape of the main body portion 51 is not limited thereto. For example, the main body portion 51 may be in the shape of a cylinder or a rectangular tube. In this case, the sectional area of the inner space S is set such that the visual field of the imaging camera 13 is not blocked by the wall portion 51w, on the tip end portion 51b side.

In the embodiment described above, at least one of the inner surface 51c and the outer surface 51d of the main body portion 51 is black over the entire surface, and the color to be applied to at least one of the inner surface 51c and the outer surface 51d of the main body portion 51 may be colors other than black. The color may be a deep color capable of absorbing the background light to increase the exclusion effect of ambient light due to the darkened space. For example, a color such as navy blue, umber brown, and charcoal, in which a reflective ratio of ambient light having a wavelength close to the wavelength of the fluorescence from the observation target P is comparatively low, may be used.

In the embodiment described above, the reagent such as the fluorescence reagent is applied in advance onto the observation target P in the observation of the fluorescence image, but fluorescence not relying on the applying of the fluorescence reagent (for example, self-fluorescence) may be observed without applying the reagent onto the observation target P. In this case, according to the fluorescence observation device 1, the fluorescence observation method to be executed in the fluorescence observation device 1, and the light shielding member 50, the position of the observation target P can be matched to the focus position of the imaging camera 13 in synchronization with the darkening of the space, and thus it is possible to increase an S/N ratio of the fluorescence to be observed, and to accurately identify the observation target by observing the fluorescence image.

### INDUSTRIAL APPLICABILITY

According to one aspect, it is possible to provide a fluorescence observation method, a fluorescence observation device, and a light shielding member.

### REFERENCE SIGNS LIST

1: fluorescence observation device, 10: imaging unit (imaging portion), 11a: tip end portion, 11b: rear end portion, 40: sterilized cover, 41: attachment portion, 50, 50A: light shielding member, 51: main body portion, 51a: base end portion, 51b: tip end portion, 51c: inner surface, 51d: outer surface, 52: detachable portion, 53: curved portion, 100: placement surface, H: length, P: observation target, R: observation window, S: inner space.

1. A fluorescence observation method, comprising:
a fluorescence imaging step of imaging fluorescence from an observation target by an imaging portion,
wherein the fluorescence imaging step includes a darkening step of darkening a space between the observation target and an observation window of the imaging portion by pressing a tip end portion of a light shielding member to the observation target or a placement surface of the observation target, in a state where a base end portion of the light shielding member including a tubular main body portion is attached to the imaging portion to surround the observation window, and a focus adjustment step of adjusting a focus position of the imaging portion.

2. The fluorescence observation method according to claim 1,
wherein the focus adjustment step is performed before the darkening step, and the focus position of the imaging portion is adjusted such that the focus position of the imaging portion becomes a position of a surface including the tip end portion of the light shielding member.

3. The fluorescence observation method according to claim 1,
wherein a light shielding member having a tapered shape such that a sectional area of an inner space in the main body portion increases from the base end portion towards the tip end portion, is used as the light shielding member.

4. The fluorescence observation method according to claim 1,
wherein a light shielding member in which at least one of an inner surface and an outer surface of the main body portion is black, is used as the light shielding member.

5. The fluorescence observation method according to claim 1,
wherein a light shielding member including a curved portion conforming to a shape of the observation target on the tip end portion, is used as the light shielding member.

6. The fluorescence observation method according to claim 1,
wherein the fluorescence imaging step further includes a first attaching step of attaching a sterilized cover to the imaging portion to cover a portion excluding the observation window of the imaging portion, and a second attaching step of detachably attaching the base end portion of the light shielding member to an attachment portion with respect to the imaging portion in the sterilized cover.

7. The fluorescence observation method according to claim 1, further comprising:
a reagent applying step of applying a fluorescence reagent to the observation target,
wherein in the fluorescence imaging step, the observation target is irradiated with excitation light, and fluorescence generated at the observation target in response to the irradiation of the excitation light is imaged by the imaging portion.

8. A fluorescence observation device, comprising:
an imaging portion imaging fluorescence from an observation target; and
a light shielding member including a tubular main body portion surrounding an observation window of the imaging portion,
wherein the main body portion of the light shielding member includes,
a base end portion detachably attached to the imaging portion, and
a tip end portion pressed to the observation target or a placement surface of the observation target, and
a length of the main body portion along an axis direction is a length wherein a surface including the tip end portion is included in a focus adjustment range of the imaging portion when the base end portion is attached to the imaging portion.

9. The fluorescence observation device according to claim 8,
wherein the main body portion has a tapered shape such that a sectional area of an inner space increases from the base end portion towards the tip end portion.

10. The fluorescence observation device according to claim 8,
wherein at least one of an inner surface and an outer surface of the main body portion is black.

11. The fluorescence observation device according to claim 8,
wherein a curved portion conforming to a shape of the observation target, is provided on the tip end portion.

12. The fluorescence observation device according to claim 8,
wherein a sterilized cover is attached to the imaging portion to cover a portion excluding the observation window, and
a detachable portion detachably attached to an attachment portion with respect to the imaging portion in the sterilized cover, is provided on the base end portion.

13. A light shielding member, comprising:
a tubular main body portion configured to surround an observation window of an imaging portion imaging fluorescence from an observation target,
wherein the main body portion includes a base end portion detachably attached to the imaging portion, and a tip end portion pressed to the observation target or a placement surface of the observation target, and
a length of the main body portion along an axis direction is a length wherein a surface including the tip end portion is included in a focus adjustment range of the imaging portion when the base end portion is attached to the imaging portion.
